(19) United States
(12) Patent Application Publication
(10) Pub. No.: US 2006/0256715 A1
(43) Pub. Date: Nov. 16, 2006

(54) Protection switching and monitoring method and arrangement in a data transmission system

(76) Inventors: Andras Kalmar, Rannersdorf (AT); Wilhelm Plotz, Wien (AT)

Correspondence Address: STAAS & HALSEY LLP, SUITE 700, 1201 NEW YORK AVENUE, N.W., WASHINGTON, DC, 20005, US

(21) Appl. No.: 10/554,073

(22) PCT Filed: Apr. 2, 2004
(86) PCT No.: PCT/EP04/50431

§ 371 Date: Oct. 24, 2005

(30) Foreign Application Priority Data
Apr. 23, 2003 (DE) 103 18 426.0

(51) Int. Cl. H04J 3/14; H04J 3/04

(52) U.S. Cl. 370/228; 370/535

(57) ABSTRACT

Protection switching in a single switching device is done on both the multiplex level and the path level. The performance of a working path signal and a protection path signal in a network element is monitored in separate performance monitoring devices. The monitoring device allocated to the selected path signal is activated while the other one is deactivated. The determined performance values of both monitoring devices are added up at the end of a certain monitoring period and a resulting monitoring result corresponding to the monitoring result of the selected path signal is determined. The path signals are alarm-monitored by corresponding alarm-monitoring devices.

### CROSS REFERENCE TO RELATED APPLICATIONS

This application is based on and hereby claims priority to German Application No. 10318426.0 filed on Apr. 23, 2003, the contents of which are hereby incorporated by reference.

### BACKGROUND OF THE INVENTION

In data transmission systems protection circuits are provided to increase the transmission security. With 1+1 protection a data signal is transmitted to a receiving network element once over a working connection and a second time over a protection connection. If the working connection is interrupted the system switches over on the receive side to the protection signal transmitted via the protection connection.

In synchronous data transmission systems multiplex signals with very high data rates are frequently transmitted. Thus, in a typical “Synchronous Digital Hierarchy” SDH system described here a multiplex signal is transmitted as a rule containing at least one data signal referred to as a virtual container, but for higher data rates containing a number of virtual containers. Each of these VC-4 containers can in its turn contain a number of virtual containers of lower granularity (lower data rate). The virtual containers can in addition be transmitted over other signal paths as well, which further increases the reliability of the transmission network. Protection switching can be undertaken between the complete multiplex signals, the working and the protection multiplex signal. With path protection the switching is between working path signals and protection path signals. A path signal here is taken to mean a data signal designated as a virtual container which is transmitted as part of the multiplex signal from one subscriber to another subscriber.

The performance of the connection is constantly checked at both multiplex signal level and path level. Alarm messages are also generated for these connections. Accordingly separate cascaded protection switching devices are provided at multiplex level and at path level.

### SUMMARY OF THE INVENTION

An object of the invention is to specify an advantageous method for protection switching and for monitoring. In addition a suitable arrangement for the protection switching and monitoring is to be specified.

The particular advantage of the invention lies in the implementation of the protection switching functions at the multiplex signal level and the path level with only a single switching device.

In the invention one monitoring device is assigned to each working path signal and each protection path signal. The monitoring values determined can be transmitted at low data rates.

The performance monitoring and alarm monitoring facilities which now lie before the switching device are embodied so that, as regards their function, they essentially correspond to those supervision devices arranged after the switching devices in known systems.

### BRIEF DESCRIPTION OF THE DRAWINGS

These and other objects and advantages of the present invention will become more apparent and more readily appreciated from the following description of an exemplary embodiment, taken in conjunction with the accompanying drawings of which:

FIG. 1 is a block diagram of a ring network,

FIG. 2 a basic block diagram of known protection switching,

FIG. 3 a basic block diagram of a protection switching device in accordance with the invention.

FIG. 4 a timing diagram for performance monitoring,

FIG. 5 an expanded basic block diagram of a protection switching device in accordance with the invention,

FIG. 6 a flowchart for alarm monitoring.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

FIG. 1 shows a ring network with various network elements NE1 to NE3. Network elements NE1 and NE2 are connected to each other by a (bidirectional) working connection WV shown by a solid line and by a protection connection PV shown by a dashed line. A multiplex signal STM-N is transmitted both over the working connection and also over the protection connection from network element NE1 to network element NE2. The opposite direction does not need to be considered here. The working multiplex signal sent over the working connection WV is labelled STM-NW and the protection multiplex signal sent over the protection connection PV is labelled STM-NP. Further protection connections PPV can also be present.

First the function of the known protection switching facilities and of the associated performance monitoring for an SDH system should be explained with reference to the basic block diagram shown in FIG. 2. This shows the connection between a transmitter TR of the network element NE1 over the working connection WV and the protection connection PV and a receive-side protection switching facility PRS in the receive section of the network element NE2.

A data source 13, here a VC-4-source, delivers a VC-4 path signal which is combined with further VC-4 path signals into a multiplex signal STM-N (transport module) and is output by an STM source 14. For 1+1 protection this multiplex signal is transmitted both as a working multiplex signal STM-NW via an STM working source 15 and a working connection WV and also as a protection multiplex signal STM-NP via an STM protection source 16 and a protection connection PV to the receive part. Here the working multiplex signal STM-NP (also an STM-1 signal) is checked in a working termination unit 17 and the protection multiplex signal STM-NP in a protection termination unit 18. Depending on the result of the check, the multiplex signal switch 24 is controlled which through connects the better (or only available) working multiplex signal STM-NW or STM-NP if the working multiplex signal STM-NW fails, a switch is made to the complete protection multiplex signal STM-NP.

In FIG. 2 the starting point is taken as an STM-4 signal. This is demultiplexed in a demultiplexer 19 (shown simplified) into four path signals, which are referred to as VC-4 signals or VC-4 containers VC-4,1-VC-4,N (N=4) (if the transmitted multiplex signals are for example an STM-16 signal, then each working multiplex signal contains 16 VC-4 containers). The path signals are routed to a path switching device 26 which is only represented in the diagram by a single switch, and monitored in VC-4 monitoring devices 20 (of which likewise only one is shown).

The arrangement shown can also be expanded for more than one protection signal. Further VC-4 signals VC-4PP can be received via a path protection connection. The quality of these virtual containers VC-4PP is checked in a further VC-4 monitoring device 21. A control not shown in this Figure evaluates the VC-4 monitoring results of the VC-4 monitoring devices 20 and 21 and controls a path switcher 26. The selected VC-4 path signal is terminated at a VC-4 termination unit 23, i.e. freed from overhead and monitored by a performance monitoring device. Optionally a multiplex signal protection, path protection or a mixed form of this can be used.

With this known arrangement, the protection switching has thus been undertaken at the multiplexing level in a first switching device 24 and at the path level in a second switching device 26. A performance monitoring or alarm monitoring at path level is not undertaken until after the selection of the better path signals in the path monitoring facilities 23.

A performance monitoring is used to constantly check the status of a path connection and to generate the performance results in specific states. In particular quality information is provided for the signal (for example VC-4) selected and routed to the subscriber (customer), in which case it does not matter whether this signal is transmitted over the working or the protection connection. Suitable measured values can for example be parity errors or times at which receive quality is bad. With an SDH system performance monitoring is known as the f31 function.

Alarm monitoring (fault management) serves to determine the causes of faults in the SDH system and in particular includes f3, f4 functions.

FIG. 3 shows a basic and much simplified diagram of an inventive arrangement for protection switching and for monitoring the receive part of the network element NE2. The Figure only shows the most important functional units. The working multiplex signal STM-NW sent out by network element NE1 is routed via the working connection WV to a working terminal 1 of a working line WL and the protection multiplex signal STM-NP is routed via a protection connection PV to protection terminal 2 of a protection line PL. In a working demultiplexer 19 and a protection demultiplexer 25 the working multiplex signal STM-NW and the protection multiplex signal STM-NP are first divided up into a number of working path signals VC-4W1-VC-4WN and a number of protection path signals VC-4P1-VC-4PN, which are routed via separate working path lines WL1-WLN and protection path lines PL1-PLN to a switching device 11 (likewise division into signals of smaller granularities, i.e. into signals with an even lower data rate and their monitoring is possible). At the signal outputs 12 all VC-4 containers contained in the selected working multiplex signals STM-NW or STM-NP are output.

Both at the working line WL and also at the protection line PL the inputs are connected to a protection monitoring device 3 at working multiplex signal level. The function of this device will now be explained in greater detail. A switch from the working connection WV to the protection connection PV is undertaken, as already described, if the signals STM-NW received over the working connection have a lower quality than the signals received over the protection connection PV or even if the working connection is interrupted. The switch from working signal STM-NW to the protection signal STM-NP is undertaken via the switching device 11, which in this case through-connects all virtual VC-4 signals of the selected multiplex signal at path level and in this way brings about protection switching at multiplex signal level.

The switching device 11 is activated by the protection switching device 3 via a control line 33.

As well as the complete switching between multiplex signals, switching at path level, i.e. here individual VC-4 path signals or groups of VC-4 signals can be undertaken, which will be initiated by the VC-4 monitoring devices 20, 21, 22 (FIG. 5). The single switching device 11 is controlled via the protection monitoring device 3 or a further control. In FIG. 3 all working path signals have been selected.

Connected to each of the path lines WL1-WLN and PL1-PLN are a working performance monitoring device 8 and a working alarm monitoring device 5 or a protection performance monitoring device 9 and a protection alarm monitoring device 6 respectively for monitoring a respective VC-4 path signal. Only one of the performance monitoring devices and one of the alarm monitoring devices respectively for the path lines WL1 and PL1 are shown in the diagram. The performance monitoring devices 8 and 9 are controlled by the protection monitoring device 3. The outputs of the performance monitoring devices 8 and 9 are routed to an accumulation device 10 which outputs the resulting performance values PW.

The outputs of the alarm monitoring devices 5 and 6 for the path level are routed to an alarm switching device 7 which outputs an alarm signal AS. The alarm signal and the performance signal as a rule contain a number of items of individual information.

The alarm monitoring devices 5, 6 and the alarm switching device 7 are controlled by an alarm selection circuit 4 to which in its turn the switchover criterion is routed from the protection monitoring device 3.

In accordance with the invention the performance of the selected path signal is no longer monitored, but instead the working performance monitoring device 8 performs the monitoring for the working container VC-4W1 and the protection performance monitoring device 9 performs the monitoring for the protection container VC-4P1 separately. If the working signal STM-NW is through connected, only the associated working performance monitoring device 8, which for example adds up faults or times at which reception is bad, is in operation, and the associated protection performance monitoring device 9 is idle.

The way in which performance monitoring operates when faults are being measured will be explained in greater detail with reference to FIG. 4. Initially, at the beginning of a measurement period t0 the working signal is through-connected and the fault values measured by the working performance monitoring device 8, the performance values FW, are summed.

If now, at time t1 a switch is made to the protection signal STM-NP, the measurement result of the working performance monitoring device 8 remains stored, the protection performance supervision device 9 is activated and accumulates as a second performance signal FP the faults of the protection signal STM-NP, i.e. only the signal which is through connected in each case is monitored before through connection.

At time t2 a switch is made back to the working signal; Now the protection performance monitoring 9 idles again and the faults of the working signal continue to be accumulated. At the end of the monitoring period t3 the accumulated performance values FW and FP are added in the accumulation device 10 to form a resulting performance value PW which then corresponds to that of the selected path signal. The resulting performance signal PW is made available to the subscriber or to a network management system. If the performance monitoring facilities 8, 9 or the accumulation device 10 are appropriately embodied it is also possible to undertake permanent monitoring of the working and the protection connection and to determine a resulting performance signal.

FIG. 5 shows the arrangement in accordance with the invention once more as a detailed diagram which, on the send side, does not differ from the known arrangement shown in FIG. 2. On the receive side, in addition to the arrangement shown in FIG. 3 corresponding to FIG. 2 however there is a termination unit 17 for the working signal STM-NW and a further termination unit 18 for the protection signal STM-NP. The multiplex signals are monitored by these termination units 17 and 18. The signals are divided into working path signals VC-4W1-VC-4WN in a working demultiplexer 19, and are divided into protection path signals VC-4P1-VC-4PN in a protection demultiplexer 25.

Only one switching device 11 is present containing only path switchers. One of these switches is shown.

For a switch between the complete working signal STM-NW and the complete protection multiplex signal STM-NP the switching function of the multiplex signal switcher 24 (FIG. 2) is now implemented by the switches of the switching device 11, in that a switchover is made from all VC-4 containers of the working multiplex signal to the VC-4 containers of the protection multiplex signal. This complete switchover is generally initiated by the termination units 17 and 18 and the protection monitoring device 3.

In this case a further switching option (not shown) in the area of the termination devices 17 and 18 for choosing a relevant selected overhead of the signals STM-NW or STM-NP can be provided.

Through the alarm switching device 11 it is also possible to chose in each case, between individual path signals VC-4PP transmitted over the working connection WV and over the protection connection PV or over the additional protection connection PPV. This means that the better-quality path signals at the VC-4 level can be selected in each case. The switching of individual VC-4 subsignals is initiated via the VC-4 monitoring devices 20, 21, 22, . . . . In this Figure only the selection of one protection path signal VC-4PN has been shown.

The two corresponding VC-4 signals are monitored in each case by the VC-4 monitoring devices 20 and 22, which lie before the alarm switching device. In the related art (FIG. 2) only one monitoring device 20 is provided, which is arranged after the multiplex switch 24.

As well as performance monitoring alarm monitoring is provided, which is referred to in the SDH system as fault management and is described by functions f1-f8. The main functions f3 and f4 are entered in FIG. 3. As with performance monitoring a working alarm monitoring device 5 and a protection alarm monitoring device 6 are provided at path level. Were only one alarm monitoring device to be used, the selected working multiplex signal (in a similar way to previous performance monitoring) would have to be routed to this. The faults which occur are monitored and correlated in each case by the f3 filter and their cause is also determined, while the f4-filter performs time integration and only passes on faults which are present over the long term. In accordance with the selected signal STM-NW or STM-NP or the selected path signal the alarm message ASW or ASP of the associated alarm monitoring 5 or 6 is selected, and thereby an alarm signal AS which generally consists of different individual messages is output to avoid Irritations from rapid consecutive changes to the alarm signal, the alarm signals of the new selected signal are not however forwarded immediately after a switch between working and protection signal. Instead an alarm signal corresponding to the time conditions is to be forwarded which largely corresponds to the signal during alarm monitoring of a selected path signal.

FIG. 6 shows a flowchart to illustrate the alarm signalling processes which run in parallel in the alarm monitoring devices 5 and 6 (FIG. 2). For each protection switch-initiated by the protection switching signal PSW-two timers implemented in the f4 function of the effective alarm monitoring device, known as a RAISE timer RT and a CLEAR timer CT, are reset. Only if the output signals of the f3 and f4 function match is the existing alarm message changed. The requirement for a change to the alarm message is also that the monitoring times, referred to as RAISE time and CLEAR time, have elapsed (at least if the alarm signals of the working path signal and of the associated protection path signal are different)

Initially for example the system asks whether the f3 and f4 alarms have been raised: “f3 A f4 RAISED?”. If they have, a check is made as to whether the RAISE TIME has elapsed. If this condition is also fulfilled an alarm message RAISE ALARM is output. If no f3 and f4 error messages are present, the system asks if both f3 and f4 are not issuing any error messages: “f3 A f4 CLEARED?”. If this condition is fulfilled, the state of the CLEAR timer CT is checked. If the “CLEAR-TIME” has elapsed, the alarm “CLEAR Alarm” is deleted. Both error messages “RAISE ALARM” and “CLEAR ALARM” are needed for normal alarm processing. If the timing conditions are not fulfilled, an f3Af4 request is made again.

Even if instead of 1+1 protection, a 1:1 or 1:N protection is provided, in which a protection signal is only issued in the event of a fault, the same circuit arrangement can be used.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-8. (canceled)

9. A method for protection switching and monitoring in a data transmission system by transmitting a working multiplex signal over a working connection and a protection multiplex signal over a protection connection between network elements and at least one of multiplex signal protection switching between the working and protection multiplex signals and path protection switching between path signals along with monitoring performance of selected path signals, comprising:
dividing the working multiplex signal into working path signals and the protection multiplex signal into protection path signals;
routing the working path signals and the protection path signals to only one switching device both for multiplex signal protection switching and for path protection switching,
switching all path signals for the multiplex signal protection switching;
monitoring performance of the working path signals and the protection path signals before the switching device;
accumulating performance values of at least one of the working path signals and associated protection path signals; and
determining a resulting performance value when a monitoring period ends.

10. A method in accordance with claim 9, wherein said monitoring of performance is undertaken separately for the working path signal in a working performance monitoring device and in a protection performance monitoring device for a corresponding protection path signal.

11. A method in accordance with claim 10, wherein said monitoring comprises checking a plurality of protection connections.

12. A method in accordance with claim 10, wherein said monitoring comprises checking only specific parts of at least one of the working multiplex signals and lower granularity path signals.

13. A method in accordance with claim 9,
wherein said monitoring comprises alarm monitoring of the working path signals and the associated protection path signals before the switching device, and
passing on alarm criteria of each signal selected.

14. A method in accordance with claim 13, further comprising changing an alarm-criterion of one of a newly selected working path signal and a newly selected protection path signal after protection switching and a checking time has elapsed.

15. A system for protection switching and monitoring in a data transmission system transmitting, between network elements, at least one of a working multiplex signal over a working connection and a protection multiplex signal over a protection connection, and performing at least one of multiplex signal protection switching between the working and protection multiplex signals and path protection switching between path signals along with monitoring performance of selected path signals, comprising:
only one switching device to which the working path signals are routed over working path lines and the protection path signals are routed over protection path lines, with the multiplex signal protection switching being undertaken by switching all path signals;
a working performance monitoring device connected to each of the working path lines;
a protection performance device connected to each of the protection path lines;
an accumulation device accumulating performance values of at least one of the working path signals and associated protection path signals; and
alarm monitoring devices, connected to the accumulation, device, determining resulting performance values.

16. A system according to claim 15,
further comprising alarm switching devices,
wherein said alarm monitoring devices include working alarm monitoring devices respectively connected to the working path lines and protection alarm monitoring devices respectively connected to one of the protection path lines, where working alarm signals are routed from the working alarm monitoring devices and protection alarm signals are routed from associated protection alarm monitoring devices to the alarm switching devices, respectively, and
wherein each alarm switching device is activated by an alarm control to which a protection switching signal is routed and a path alarm signal of a newly selected path signal is through connected via a corresponding alarm switching device only after a checking time has elapsed.
